(19) United States
(12) Patent Application Publication
(10) Pub. No.: US 2008/0217131 A1
(43) Pub. Date: Sep. 11, 2008

(54) DUAL ONE-WAY CLUTCH ASSEMBLY

(75) Inventors: Scott H. Wittkopp, Ypsilanti, MI (US); James M. Hart, Belleville, MI (US); Clinton E. Carey, Monroe, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/681,803

(22) Filed: Mar. 5, 2007

(51) Int. Cl. F16D 11/06

(52) U.S. Cl. 192/43.1

(57) ABSTRACT

A device for transmitting torque between a first component and a second component is provided. The device includes a first race coupled to the first component and a second race coupled to the second component. The second race is disposed concentrically with the first race. A first rocker is pivotally connected to the first race and is moveable to rotationally fix the first race to the second race to transfer torque therebetween. A second rocker is pivotally connected to the first race and is disposed axially adjacent to the first rocker. The second rocker is moveable to rotationally fix the first race to the second race to transfer torque therebetween. A selector ring is disposed between the first race and the second race. The selector ring is moveable to engage the first rocker to prevent the first rocker from engaging the second race.

### FIELD

The present disclosure relates to torque transmitting devices, and more particularly to a torque transmitting device having a plurality of clutches.

### BACKGROUND

The statements in this section merely provide background information related to the present disclosure and may not constitute prior art.

There are many devices for transmitting torque known in the art. Examples include hydraulically actuated clutch plates, dog clutches actuated by shift forks, and one-way clutches. These devices are able to transmit torque between two separate components, and each are useful for their intended purpose.

The one-way clutch is a compact design used in many applications for transmitting torque in one rotational direction. A typical one-way clutch includes an inner ring disposed within an outer ring. A connecting member is located between the rings for selectively transmitting torque between the rings. The connecting member may take various forms, for example, a sprag, roller, or diode. The connecting member acts to engage the rings in order to transmit torque when one of the rings is rotated in a first direction. If the rings are rotated in an opposite direction, the connecting member does not engage the rings, and torque is not transmitted through the one-way clutch. In this way the one-way clutch is effective in transmitting torque between two components.

However, a known limitation with a one-way clutch is that different torque settings cannot be selected. While various solutions have been provided in the past, there remains room in the art for improvement in providing a selectable clutch assembly that includes desirable packaging flexibility, component size advantages, control complexity, and decreased torque losses.

### SUMMARY

It is an object of the present invention to provide the art with a device for transmitting torque between a first component and a second component.

In one aspect of the present invention, the device includes a first race coupled to the first component, a second race coupled to the second component, the second race disposed concentrically with the first race, a first rocker pivotally connected to the first race, the first rocker moveable to rotationally fix the first race to the second race to transfer torque therebetween, a second rocker pivotally connected to the first race, the second rocker disposed axially adjacent to the first rocker, the second rocker moveable to rotationally fix the first race to the second race to transfer torque therebetween, and a selector ring disposed between the first race and the second race, the selector ring moveable to engage the first rocker to prevent the first rocker from engaging the second race.

In another aspect of the present invention, the first rocker engages the second race when rotated in a first direction.

In yet another aspect of the present invention, the second rocker engages the second race when rotated in a second direction.

In still another aspect of the present invention, the second race has an inner surface forming an at least one pocket, and the first rocker and the second rocker are moveable to engage the first pocket to transmit torque between the first race and the second race.

In still another aspect of the present invention, the second race has an inner surface forming a first pocket radially adjacent to a second pocket, and the first rocker is moveable to engage the first pocket and the second rocker is moveable to engage the second pocket.

In still another aspect of the present invention, the first rocker has a first extending arm biased to pivot toward the second race in the first direction, the first extending arm engaging the first pocket to rotationally fix the first race to the second race to transmit torque therebetween.

In yet another aspect of the present invention, the first extending arm moves out of the first pocket when the first extending arm is rotated in the second direction thereby not transmitting torque between the first race and second race.

In yet another aspect of the present invention, the second rocker has a second extending arm biased to pivot toward the second race in the second direction, the second extending arm engaging the second pocket to rotationally fix the first race to the second race to transmit torque therebetween.

In still another aspect of the present invention, the second extending arm moves out of the second pocket when the second extending arm is rotated in the second direction thereby not transmitting torque between the first race and second race.

In still another aspect of the present invention, the first race includes a first inner portion and a second inner portion, the first inner portion having the first rocker, the second inner portion having the second rocker.

In yet another aspect of the present invention, the second race includes a first outer portion and a second outer portion, the first outer portion having the first pocket formed thereon, the second outer portion having the second pocket formed thereon.

In yet another aspect of the present invention, the first inner portion is connected to the second inner portion by an at least one connector,

In yet another aspect of the present invention, the first inner portion is connected to the second outer portion by an at least one connector.

It is an object of the present invention to provide the art with a second device for transmitting torque between a first component and a second component.

In one aspect of the present invention, the device includes a first race, a second race disposed radially outward of the first race, the second race having a first pocket, a third race disposed radially outward of the second race, the third race having a second pocket, a first rocker pivotally connected to the first race, the first rocker moveable to engage the first pocket to rotationally fix the first race to the second race to transfer torque between the first component and the second component, a second rocker pivotally connected to the second race, the second rocker moveable to engage the second pocket to rotationally fix the second race to the third race to transfer torque between the first component and the second component, and a selector ring disposed between the second race and the third race, the selector ring moveable to engage the second rocker to prevent the second rocker from engaging the second pocket.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a schematic view of a rocker one-way clutch according to the principles of the present invention;

FIG. 1B is a schematic view of a selectable rocker one-way clutch according to the principles of the present invention;

FIG. 2 is a schematic view of a dual clutch assembly according to one embodiment of the present invention;

FIG. 3 is a schematic view of a dual clutch assembly according to a second embodiment of the present invention; and

FIG. 4 is a schematic view of a dual clutch assembly according to a third embodiment of the present invention.

### DETAILED DESCRIPTION

The following description is merely exemplary in nature and is not intended to limit the present disclosure, application, or uses.

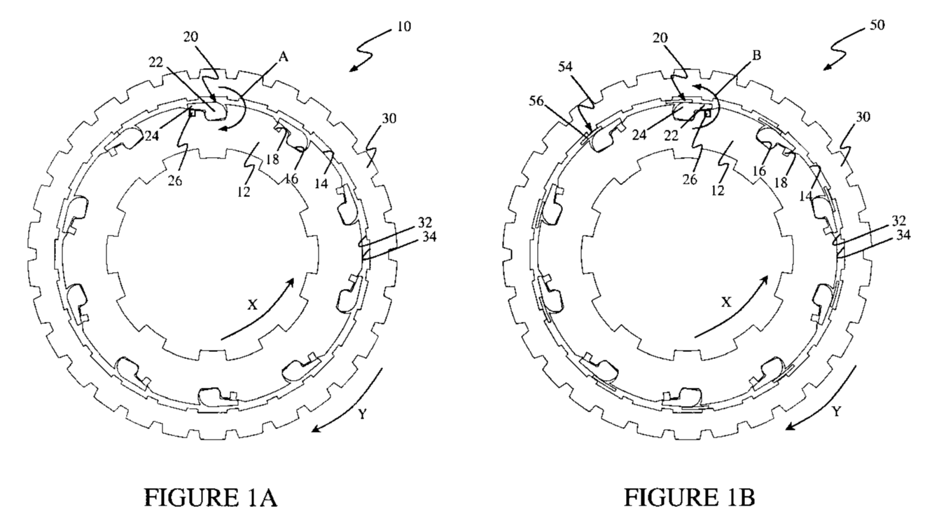

In order to provide a clear description of the present invention, two clutches, illustrated in FIGS. 1A and 1B, will first be described. These two clutches are employed throughout the various embodiments of the present invention.

With reference to FIG. 1A, a rocker one-way clutch 10, or clutch 10, employed in the present invention is illustrated. The clutch 10 includes a first race 12. The first race 12 is annular in shape and includes an outer surface 14. A plurality of recesses 16 are formed in the outer surface 14 and are spaced annularly around the inner perimeter of the first race 12. A plurality of slots 18 are also formed on the outer surface 14 and the slots 18 are spaced annularly around the inner circumference of the first race 12. The slots 18 are disposed adjacent to the recesses 16.

The clutch 10 further includes a plurality of rockers 20. The rockers 20 include a body 22 and an arm 24. The arm 24 extends away from the body 22. The rockers 20 are pivotally connected to the outer surface 14 of the first race 12 such that for each rocker 20, the body 22 fits within a recess 16, and the arm 24 extends over an adjacent slot 18. As will be described in further detail below, the rockers 20 are designed to selectively transmit torque through the clutch 10.

A plurality of biasing members 26 are disposed within the slots 18. In the present example the biasing members 26 are coil springs, but it should be appreciated that various other types of biasing members may be employed. The biasing members 26 engage the arm 24 and urge the rocker 20 to rotate in a first direction A. In the present example the first direction A is illustrated as rotationally clockwise, but it should be appreciated that the rockers 20, slots 18, and biasing members 26 may be oriented in an opposite direction such that the rotation in the first direction A is counter-clockwise.

The clutch 10 also includes a second race 30. The second race 30 is disposed radially outward of the first race 12 such that the rockers 20 are disposed between the first race 12 and the second race 30. The second race 30 is concentric to the first race 12. The second race 30 is generally annular in shape and includes an inner surface 32. A plurality of pockets 34 are formed on the inner surface 32 and are spaced annularly around the inner circumference of the second race 30.

Torque is transmitted through the clutch 10 when the first race 12 is rotationally fixed to the second race 30 by the clockwise rotation of the rockers 20. More specifically, engagement of the rockers 20 to the second race 30 occurs when the first race 12 rotates in a direction X as indicated in FIG. 1A or when the second race 30 rotates in a direction Y as indicated in FIG. 1A. Specifically, the rockers 20 are biased to rotate in the first direction A such that the arms 24 engage the pockets 34 of the second race 30. This engagement by the rockers 20 rotationally fixes the first race 12 and the second race 30 together. Disengagement of the rockers 20 to the second race 30 occurs when the first race 12 in the direction Y or when the second race 30 rotates in the direction X. The inner surface 32 of the second race 30 urges the rockers 20 to rotate in a direction opposite to the first direction A, and the arms 24 move out of the pockets 34 of the second race 30. This disengagement of the rockers 20 allows the first race 12 and the second race 30 to rotate freely with respect to one another.

FIG. 1B illustrates a selectable rocker one-way clutch 50, or selectable clutch 50. The selectable clutch 50 is substantially identical to the clutch 0l however, the rockers 20 and slots 18 are oriented in an opposite direction to the rockers 20 and slots 18 in the clutch 10. Specifically, the biasing member 26 engages the arm 24 and urges the rocker to rotate in a second direction B. The second direction B is rotationally opposite to the first direction A. In the present example the second direction B is illustrated as rotationally counter-clockwise, but it should be appreciated that the rockers 20, slots 18, and biasing members 26 may be oriented in an opposite direction such that the rotation of the second direction A is clockwise so long as the rockers 20, slots 18, and biasing members 26 of the clutch 10 are similarly re-oriented such that the rockers 20 of the clutch 10 are biased in a direction opposite to the rockers 20 of the selectable clutch 50.

The selectable clutch 50 further includes a selector ring 54. The selector ring 54 is disposed between the first race 12 and the second race 30 and is concentric to the first race 12. The selector ring 54 includes a plurality of tabs 56 that extend in an axial direction relative to the selectable clutch 50. The selector ring 54 is rotationally moveable by an actuator (not shown) between a first position and a second position. When the selector ring 54 is in the first position, the tabs 56 engage the rockers 20 and prevent the rockers 20 from rotating into pockets 34. The first position is illustrated in FIG. 1B. When the selector ring 54 is in the second position, the tabs 56 do not engage the rockers 20 and the rockers 20 are allowed to rotate unimpeded.

Torque is transmitted through the selectable clutch 50 in a manner similar to the clutch 10. Engagement of the rockers 20 to the second race 30 occurs when the first race 12 rotates in the direction Y or when the second race 30 rotates in the direction X. Specifically, when the rockers 20 are biased to rotate in the second direction B such that the arms 24 engage the pockets 34 of the second race 30. This engagement by the rockers 20 rotationally fixes the first race 12 and the second race 30 together. Disengagement of the rockers 20 from the second race 30 occurs when the first race 12 rotates in the direction X or when the second race 30 rotates in the direction Y. The inner surface 32 of the second race 30 urges the rockers 20 to rotate in a direction opposite to the second direction B, and the arms 24 move out of the pockets 34 of the second race 30. This disengagement by the rockers 20 allows the first race 12 and the second race 30 to rotate freely with respect to one another. When the selector ring 54 is moved to the first position, as noted above, the tabs 56 prevent the rockers 20 from rotating to engage the second race 30. The selector ring 54 thereby prevents transmission of torque through the selectable clutch 50 irrespective of the relative movements between the first race 12 and the second race 30, essentially allowing the first race 12 and the second race 30 to rotate relative to one another unimpeded.

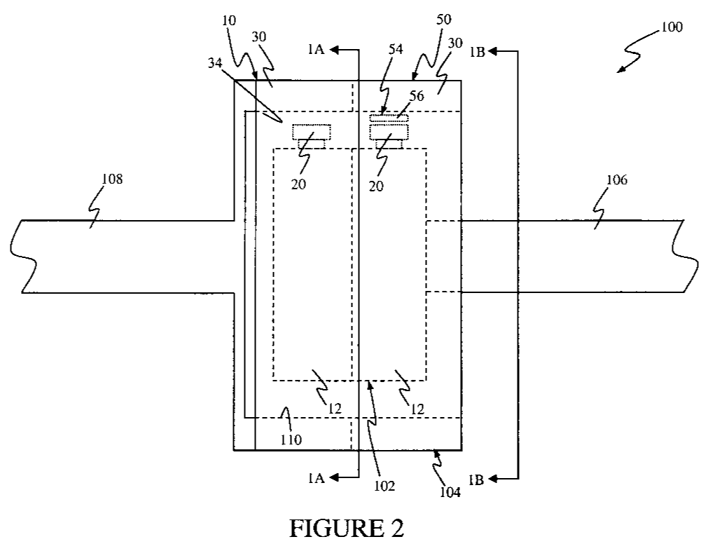

Turning now to FIG. 2, a first clutch assembly 100 employing the clutch 10 and the selectable clutch 50 is illustrated, in accordance with an embodiment of the present invention. The clutch 10 is disposed axially adjacent to the selectable clutch 50. The first race 12 of the clutch 10 is rotationally fixed to the first race 12 of the selectable clutch 50 forming an inner race 102.

The second race 30 of the clutch 10 is rotationally fixed to the second race 30 of the selectable clutch 50 forming an outer race 104. The inner race 102 is coupled to a first component 106 and the outer race 104 is coupled to a second component 108. The clutch 10 and the selectable clutch 50 are oriented within the first clutch assembly 100 such that the rockers 20 of the clutch 10 are oriented opposite to the rockers 20 of the selectable clutch 50. Specifically, arrow 1A-1A and arrow 1B-1B correspond to the views in FIGS. 1A and 1B, respectively

The rockers 20 of the clutch 10 are disposed axially adjacent to the rockers 20 of the selectable clutch 50. In the example provided the rockers 20 of the clutch 10 and the rockers 20 of the selectable clutch 50 are aligned with one another axially, however, it should be appreciated that the rockers 20 may be positioned out of alignment axially to one another. Additionally, the pockets 34 of the clutch 10 and the pockets 34 of the selectable clutch 50 may be aligned to form a single pocket 110, or alternatively remain discrete separate pockets.

During operation of the first clutch assembly 100, one or both of the first component 106 and the second component 108 are rotatable. Additionally, one of the first component 106 and the second component 108 may be fixed from rotation. Torque is transmitted between the first component 106 and the second component 108 when the rockers 20 of the clutch 10 couple the inner race 12 to the outer race 30 (as shown and described in FIG. 1A) and when the rockers 20 of the selectable clutch 50 couple the inner race 12 to the outer race 30 (as shown and described in FIG. 1B). This in turn couples the inner race 102 to the outer race 104. Torque is not transmitted between the first component 106 and the second component 108 when the selector ring 54 is in the first position and prevents the rockers 20 of the selectable clutch 50 from engaging the outer race 104. It should be appreciated that the orientations of the clutch 10 and selectable clutch 50 may be reversed to allow for specific directions of torque transfer and free movement.

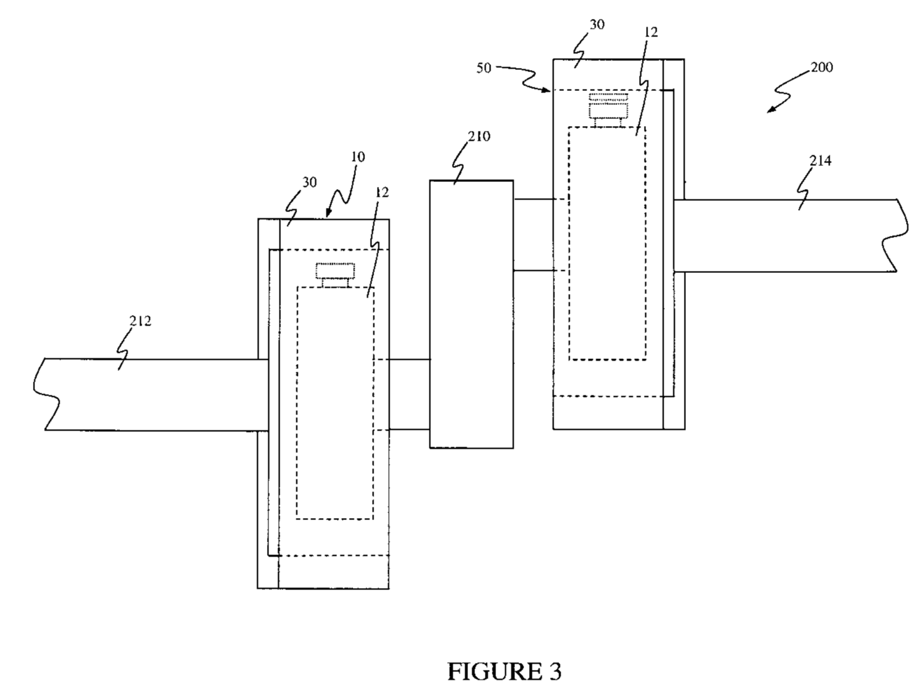

FIG. 3 illustrates a second clutch assembly 200 according to the principles of the present invention. The second clutch assembly 200 is similar to the first clutch assembly 100 shown in FIG. 2 in that the second clutch assembly 200 includes the clutch 10 coupled with the selectable clutch 50. However, in the second clutch assembly 200, the clutch 10 is displaced from the selectable clutch 50. More specifically, the clutch 10 is displaced from the selectable clutch 50 in an axial direction and in a radial direction, though it should be appreciated that any configuration of displacement may be employed.

The first race 12 of the clutch 10 is coupled to the first race 12 of the selectable clutch 50 by a coupling 210. The coupling 210 may be any assembly operable to transmit torque between the clutch 10 and the selectable clutch 50, such as, for example, a gear box having pinions or bevel gears. The second race 30 of the clutch 10 is coupled to a first component 212, which is preferably a shaft. The second race 30 of the selectable clutch 50 is coupled to a second component 214. The first and second components 212, 214 are both preferably shafts, though various other devices may be employed. Additionally, the first component 212 and the second component 214 may either be rotatable or fixed. Torque is transmitted through the second clutch assembly 200 in a manner substantially similar to that of the first clutch assembly 100 in FIG. 2. Alternate embodiments of the second clutch assembly 200 that vary the connections between the races 12, 30 of the clutches 10, 50 may be employed without departing from the scope of the present invention. For example, the first component 212 may be coupled to the first race 12 of the clutch 10, or the second component 214 may be coupled to the first race 12 of the selectable clutch 50. Additionally, the coupling 210 may extend between the second race 30 of the clutch 10 and the second race 30 of the selectable clutch 50, or extend between one of the races 12 of the clutches 10, 50 to one of the race 30 of the clutches 10, 50.

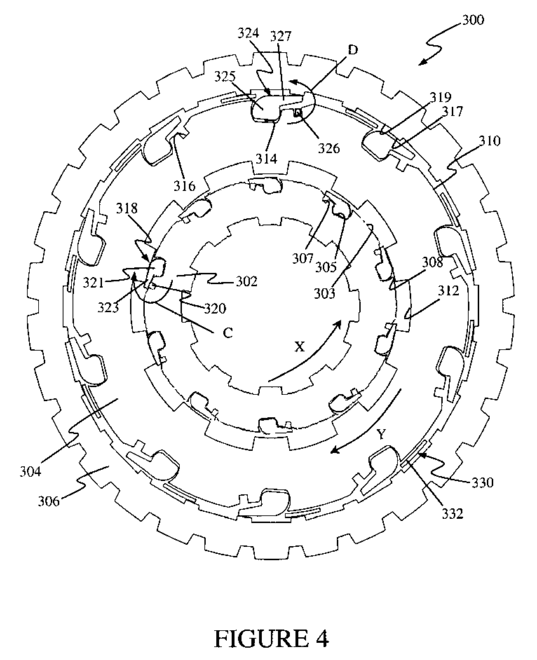

FIG. 4 illustrates a third clutch assembly 300 according to the principles of the present invention. The third clutch assembly 300 includes a first race 302, a second race 304, and a third race 306 substantially similar to the second race 30 of the clutch 10 illustrated in FIG. 1A. The second race 304 is disposed radially outward of the first race 302 and is concentric with the first race 302. The third race 306 is disposed radially outward of the second race 304 and is also concentric with the first race 302.

The first race 302 is substantially similar to the first race 12 of the clutch 10 illustrated in FIG. 1A and includes an outer surface 303, a plurality of recesses 305 formed in the outer surface 303, and a plurality of slots 307 formed on the outer surface 303 and disposed adjacent to the recesses 305.

The second race 304 includes an inner surface 308 and an outer surface 310. A plurality of pockets 312 are formed on the inner surface 308 and are spaced annularly around the inner circumference of the second race 304. A plurality of recesses 314 are formed on the outer surface 310 and are spaced annularly around the outer circumference of the second race 304. A plurality of slots 316 are also formed in the outer surface 310 and are spaced annularly around the outer circumference of the second race 304. The slots 316 are disposed adjacent to the recesses 314.

The third race 306 is substantially similar to the second race 30 of the clutch 10 illustrated in FIG. 1A and includes an inner surface 317. A plurality of pockets 319 are formed on the inner surface 317 and are spaced annularly around the inner circumference of the third race 306.

The third clutch assembly 300 further includes a plurality of first rockers 318. The first rockers 318 are substantially similar to the rockers 20 of the clutch 10 and selectable clutch 50 illustrated in FIGS. 1A and 1B. The first rockers 318 include a body 321 and an arm 323. The first rockers 318 are pivotally connected to the outer surface 303 of the first race 302 such that for each first rocker 318, the body 321 fits within a recess 305, and the arm 323 extends over an adjacent slot 307. As will be described in further detail below, the rockers 318 are designed to selectively engage and disengage the second race 304 to transmit torque through the third clutch assembly 300.

A plurality of first biasing members 320 are disposed within the slots 307. The biasing members 320 are substantially similar to the biasing members 26 of the clutch 10 in FIG. 1A. The biasing members 320 engage the arm 323 and urge the rocker 318 to rotate in a first direction C. In the present example the first direction C is illustrated as rotationally clockwise, but it should be appreciated that the rockers 318, slots 307, and biasing members 320 may be oriented in an opposite direction such that the rotation in the first direction C is counter-clockwise.

The third clutch assembly 300 further includes a plurality of second rockers 324. The plurality of second rockers 324 are substantially similar to the rockers 20 of the clutch 10 and selectable clutch 50 in FIGS. 1A and 1B. The second rockers 324 include a body 325 and an arm 327. The second rockers 324 are pivotally connected to the outer surface 310 of the second race 304 such that for each second rocker 324, the body 325 fits within a recess 314, and the arm 327 extends over an adjacent slot 316. The second rockers 324 are oriented in an opposite direction to the first rockers 318. As will be described in further detail below, the second rockers 324 are designed to selectively engage and disengage the third race 306 to transmit torque through the third clutch assembly 300.

A plurality of second biasing members 326 are disposed within the slots 316. The biasing members 326 are substantially similar to the biasing members 26 of the clutch 10 in FIG. 1A. The biasing members 326 engage the arm 327 and urge the second rocker 324 to rotate in a second direction D. In the present example the second direction D is illustrated as rotationally counter-clockwise, but it should be appreciated that the second rockers 324, slots 316, and biasing members 326 may be oriented in an opposite direction such that the rotation in the second direction D is clockwise so long as the second rockers 324, slots 316, and biasing members 326 are oriented opposite to the first rockers 318, slots 18, and biasing members 320.

The third clutch assembly 300 further includes a selector ring 330. The selector ring 330 is substantially similar to the selector ring 54 of the selectable clutch 50 in FIG. 1B. The selector ring 330 is disposed between the second race 304 and the third race 306 and is concentric with the first race 302. The selector ring 330 includes a plurality of tabs 332 that extend in an axial direction relative to the third clutch assembly 300. The selector ring 330 is rotationally moveable by an actuator (not shown) between a first position and a second position. When the selector ring 330 is in the first position, the tabs 332 are positioned between the arms 327 and the third race 306 and thereby prevent the second rockers 324 from rotating and engaging the recesses 319 in the third race 306. When the selector ring 330 is in the second position, the tabs 332 are not between the arms 327 and the third race 306 and therefore the second rockers 324 are allowed to move unimpeded. The second position of the selector ring 330 is illustrated in FIG. 4.

Torque is transmitted through the third clutch assembly 300 when the first race 302 and second race 304 are rotationally fixed together by the first rockers 318. Engagement of the first rockers 318 to the second race 304 occurs when the first race 302 rotates in the direction X or when the second race 304 rotates in the direction Y or remains stationary. Specifically, the first rockers 318 are biased to rotate in the first direction C such that the arms 323 engage the pockets 312 of the second race 304. This engagement by the first rockers 318 rotationally fixes the first race 302 and the second race 304. Disengagement of the first rockers 318 to the second race 304 occurs when the first race 302 rotates in the direction Y or when the second race 304 rotates in the direction X. The inner surface 308 of the second race 304 urges the first rockers 318 to rotate in a direction opposite to the first direction C, and the arms 323 move out of the pockets 312 of the second race 304. This disengagement by the first rockers 318 allows the first race 302 and the second race 304 to rotate freely with respect to one another.

Torque is also transmitted through the third clutch assembly 300 when the second race 304 and the third race 306 are rotationally fixed together by the second rockers 324. Engagement of the second rockers 324 to the third race 306 occurs when the second race 304 rotates in the direction Y or when the third race 306 rotates in the direction X. Specifically, the second rockers 324 are biased to rotate in the second direction D such that the arms 327 engage the pockets 319 of the third race 306. This engagement by the second rockers 324 rotationally fixes the second race 304 and the third race 306 together. Disengagement of the second rockers 324 to the third race 306 occurs when the second race 304 rotates in the direction X or when the third race 306 rotates in the direction Y. Specifically, the inner surface 31 9 of the third race urges the second rockers 324 to rotate in a direction opposite to the second direction D such that the arms 327 move out of the pockets 319 of the third race 306. This disengagement by the second rockers 324 allows the second race 304 and the third race 306 to rotate freely with respect to one another. When the selector ring 330 is moved to the first position, as noted above, the tabs 332 prevent the second rockers 324 from rotating to engage the third race 306. The selector ring 330 thereby prevents transmission of torque between the second race 304 and the third race 306.

The third clutch assembly 300 allows torque to be selectively transmitted to a first component (not shown), a second component (not shown) or a third component (not shown). These components may be coupled to the first race 302, the second race 304, and/or the third race 306 in any combination. These components (not shown) may be rotatable or fixed. For example, a first shaft may be coupled to the first race 302, and a second shaft coupled to the second race 304, and a third shaft coupled to the third race 306. Torque is transferable between the first and second shafts and between the second and third shafts using the third clutch assembly 300.

The description of the invention is merely exemplary in nature and variations that do not depart from the gist of the invention are intended to be within the scope of the invention. Such variations are not to be regarded as a departure from the spirit and scope of the invention.

What is claimed is:

1. A device for transmitting torque between a first component and a second component, the device comprising:
a first race coupled to the first component;
a second race coupled to the second component, the second race disposed concentrically with the first race;
a first rocker pivotally connected to the first race, the first rocker moveable to rotationally fix the first race to the second race to transfer torque therebetween;
a second rocker pivotally connected to the first race, the second rocker disposed axially adjacent to the first rocker, the second rocker moveable to rotationally fix the first race to the second race to transfer torque therebetween; and
a selector ring disposed between the first race and the second race, the selector ring moveable to engage the first rocker to prevent the first rocker from engaging the second race.

2. The device of claim 1 wherein the first rocker engages the second race when rotated in a first direction.

3. The device of claim 2 wherein the second rocker engages the second race when rotated in a second direction.

4. The device of claim 3 wherein the first direction is opposite to the second direction.

5. The device of claim 4 wherein the second race has an inner surface forming an at least one pocket, and the first rocker and the second rocker are moveable to engage the first pocket to transmit torque between the first race and the second race.

6. The device of claim 4 wherein the second race has an inner surface forming a first pocket radially adjacent to a second pocket, and the first rocker is moveable to engage the first pocket and the second rocker is moveable to engage the second pocket.

7. The device of claim 6 wherein the first rocker has a first extending arm biased to pivot towards the second race in the first direction, the first extending arm engaging the first pocket to rotationally fix the first race to the second race to transmit torque therebetween.

8. The device of claim 7 wherein the first extending arm moves out of the first pocket when the first extending arm is rotated in the second direction thereby not transmitting torque between the first race and second race.

9. The device of claim 8 wherein the second rocker has a second extending arm biased to pivot towards the second race in the second direction, the second extending arm engaging the second pocket to rotationally fix the first race to the second race to transmit torque therebetween.

10. The device of claim 9 wherein the second extending arm moves out of the second pocket when the second extending arm is rotated in the second direction thereby not transmitting torque between the first race and second race.

11. The device of claim 6 wherein the first race includes a first inner portion and a second inner portion, the first inner portion having the first rocker, the second inner portion having the second rocker.

12. The device of claim 11 wherein the second race includes a first outer portion and a second outer portion, the first outer portion having the first pocket formed thereon, the second outer portion having the second pocket formed thereon.

13. The device of claim 12 wherein the first inner portion is connected to the second inner portion by an at least one connector.

14. The device of claim 12 wherein the first inner portion is connected to the second outer portion by an at least one connector.

15. A device for transmitting torque between a first component and a second component, the device comprising:
a first race;
a second race disposed radially outward of the first race, the second race having a first pocket;
a third race disposed radially outward of the second race, the third race having a second pocket;
a first rocker pivotally connected to the first race, the first rocker moveable to engage the first pocket to rotationally fix the first race to the second race to transfer torque between the first component and the second component;
a second rocker pivotally connected to the second race, the second rocker moveable to engage the second pocket to rotationally fix the second race to the third race to transfer torque between the first component and the second component; and
a selector ring disposed between the second race and the third race, the selector ring moveable to engage the second rocker to prevent the second rocker from engaging the second pocket.

16. The device of claim 15 wherein the first rocker engages the second race when rotated in a first direction.

17. The device of claim 16 wherein the second rocker engages the second race when rotated in a second direction.

18. The device of claim 17 wherein the first direction is opposite to the second direction.
